(19) United States
(12) Patent Application Publication
(10) Pub. No.: US 2018/0349793 A1
(43) Pub. Date: Dec. 6, 2018

(54) EMPLOYING MACHINE LEARNING AND ARTIFICIAL INTELLIGENCE TO GENERATE USER PROFILES BASED ON USER INTERFACE INTERACTIONS

(71) Applicant: Bank of America Corporation, Charlotte, NC (US)

(72) Inventors: Cory Triolo, Charlotte, NC (US); Steven Lucas, Acushnet, MA (US); Patrick W. Higgins, Saint Augustine, FL (US); Jeffrey J. Dansereau, Cumberland, RI (US)

(21) Appl. No.: 15/610,701

(22) Filed: Jun. 1, 2017

(51) Int. Cl. G06N 99/00; G06F 17/30; G06F 3/0481; G06Q 40/06

(52) U.S. Cl. CPC G06N 99/005; G06Q 40/06; G06F 3/0481; G06F 17/30002

(57) ABSTRACT

A computing platform having at least one processor, a memory, and a communication interface may receive, via the communication interface from a content management system, a first content stream containing bibliographic information and account information for a plurality of clients. A persona profile is assigned to each client, based on the bibliographic information and account information, from a plurality of predetermined persona profiles. A first set of user interface instructions is generated based on the assigned persona profile for each client and transmitted to respective remote client devices via the communication interface. A second content stream containing data of user interface interactions for the plurality of clients is received via the communication interface from an enterprise tagging server. Based on a machine learning dataset, a modified and personalized set of user interface instructions is generated and transmitted to the respective remote client devices via the communication interface.

### FIELD

Aspects of the embodiments relate to a database system that provides a technological advancement over existing database systems by customizing user interfaces in real time based on an individual's unique characteristics and interactions with the database.

### BACKGROUND

The ways that digital information is consumed are constantly evolving, and with that, expectations for those experiences are continually more demanding. Individuals often seek digital experiences that meet their unique and personal needs and that are also intuitive in function, while aesthetically pleasing. Of particular value are well-designed, streamlined experiences that are constantly optimized to best meet an individual's personal needs and growing demands.

### BRIEF SUMMARY

Aspects of the disclosure provide effective, efficient, scalable, and convenient technical solutions that address and overcome the technical problems associated with deploying computing infrastructure and providing user account portals. In particular, one or more aspects of the disclosure provide techniques for customizing user interfaces based on an individual's unique characteristics and previous interactions with the database.

In accordance with one or more embodiments, a computing platform having at least one processor, a memory, and a communication interface may receive, via the communication interface, from a content management system, a first content stream containing client bibliographic information and account information. A second content stream may be received, via the communication interface, from an enterprise tagging server, containing data of client interactions with a user interface. Responsive to receiving the first content stream and the second content stream, based on a machine learning dataset, personalized user interface instructions may be generated and transmitted to a remote client device via the communication interface.

In accordance with other embodiments, a computing platform having at least one processor, a memory, and a communication interface may receive, via the communication interface from a content management system, a first content stream containing bibliographic information and account information for a plurality of clients. A persona profile may be assigned to each client, based on the bibliographic information and account information, from a plurality of predetermined persona profiles. A first set of user interface instructions may be generated based on the assigned persona profile for each client and transmitted to respective remote client devices via the communication interface. A second content stream containing data of user interface interactions for the plurality of clients may be received via the communication interface from an enterprise tagging server. Based on a machine learning dataset, a modified and personalized set of user interface instructions may be generated and transmitted to the respective remote client devices via the communication interface.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a suitable computing system environment that may be used according to one or more illustrative embodiments.

FIG. 2 shows an illustrative system for implementing example embodiments according to the present disclosure.

FIG. 3 schematically illustrates online personalization and segmentation.

FIG. 4 is an overview of an event sequence in accordance with some aspects.

FIG. 5 shows an example of an event sequence broken down by inputs, engines, data aggregation, and user interface.

FIGS. 6A-6C show examples of screen shots of user interfaces including portfolio story, dashboard, and stock story, respectively.

FIG. 7 shows an example of a dashboard preview.

FIG. 8 shows an example of dashboard tiles that may be displayed when a client requests additional information.

FIG. 9 shows an example of dashboard tiles featuring a series of icons that may be used to display additional content and/or capture a client's preferences.

FIG. 10 shows an example of a dashboard tile in both a collapsed state and an expanded state.

FIG. 11 is an overview of an enterprise tagging (ET) system.

FIG. 12 is a schematic illustration of a machine learning/artificial intelligence (ML/AI) system that may be used in accordance with various aspects.

FIG. 13 schematically shows an example of a system design which can provide advanced real-time AI capabilities.

FIG. 14 schematically illustrates an alternative system design which can support Omni-channel analytics.

FIG. 15 schematically illustrates an example of a system that provides batch processed (non-real time) personalization analytics.

FIG. 16 schematically illustrates an example of a system that supports real time multi-layer personalization analytics.

FIG. 17 schematically shows an example of a system that supports individual design of experiments including AB testing and multivariate testing.

FIG. 18 schematically illustrates an example of a system that coordinates multiple experiments from different business partners.

FIG. 19 shows an overview for developing personalized UI instructions using clustering analysis.

FIG. 20 illustrates a clustering methodology using K-mean clustering steps.

FIG. 21 shows sequential steps which may be implemented to assign objects to clusters.

FIG. 22 depicts an illustrative method for generating personalized user interface instructions and transmitting to a remote client device for display in accordance with one or more example embodiments.

FIG. 23 depicts another illustrative method for generating user interfaces, initially based on persona profiles and then modified based on subsequent client user interface interactions in accordance with one or more example embodiments.

### DETAILED DESCRIPTION

In the following description of the various embodiments, reference is made to the accompanying drawings, which form a part thereof, and in which is shown by way of illustration various embodiments in which the disclosure may be practiced. It is to be understood that other embodiments may be utilized and structural and functional modifications may be made without departing from the scope and spirit of the present disclosure.

It is noted that various connections between elements are discussed in the following description. It is noted that these connections are general and, unless specified otherwise, may be direct or indirect, wired or wireless, and that the specification is not intended to be limiting in this respect.

The features disclosed herein overcome one or more drawbacks in prior art database systems to provide a technological improvement. In one example, a user interface is improved by prioritizing content that is more relevant to a client based on known attributes of the client and his or her account. In another example, a user interface is improved by prioritizing features that are more likely to be preferred by a client based on that client's previous interactions with the platform.

Individuals often seek digital experiences that meet their unique and personal needs and that are also intuitive in function, while aesthetically pleasing. Additional challenges are presented in the industry of self-directed investing. The user interfaces of brokerage firms typically include an enormous amount of financial information. Those who are not investment professionals often do not fully comprehend this information, do not wish to take the time to digest all of the information, and/or do not understand how to apply the information to their own unique situation. As a result, the vast majority of investors are non-engaged, characterized by infrequent (e.g., annual or semi-annual) interaction with their brokerage/retirement accounts and only limited involvement (e.g., balance-checking) in those instances when accounts are accessed.

Investors who are more knowledgeable tend to be more active. Knowledgeable inventors usually employ specific tactics and strategies to make trading and investing decisions. It would be desirable to develop better tools to help educate and engage investors. It would be particularly desirable to develop user interfaces that provide content that is customized based on such factors as the investor's unique characteristics, holdings, and previous habits with respect to interacting with the platform.

In accordance with one or more embodiments, a computing platform having at least one processor, a memory, and a communication interface may receive, via the communication interface, a first content stream containing client bibliographic information and account information. The first set of information may include items that were inputted by the client into a content management system (CMS) at the time a brokerage account was opened, such as the client's age, education, occupation, income, and so forth. The first set of information also may include data taken directly from the client's brokerage accounts, such as account type, assets under management (AUM), holdings, holding product classes, industry sectors, and days since account opening.

In some aspects, an enterprise tagging (ET) server receives the first set of information from the content management system. When the client interacts with the UI, the ET server receives additional data concerning the client's interactions, such as online login frequency, mobile login frequency, online banking login frequency, page visits, click path, trade frequency, and transfer frequency. Based on the first set of information and any additional data received, the ET server assigns a digital persona to the client. The digital persona may be selected from a small number of predetermined categories of inventors, such as “disengaged,” “passive,” “engaged,” and “active trader.” This digital persona is used to initially customize user interfaces (UIs). For example, if a client is categorized as a disengaged or passive investor, the UI may include more basic information concerning account information or a particular investment. If, on the other hand, a client is categorized as engaged or an active trader, the UI may forego the basic information and instead provide more data and market analysis relating to the investment.

In other aspects, a machine learning/artificial intelligence (ML/AI) and design of experiment (DOE) engine receives data from a number of sources, including a channel analytics data warehouse and a channel analytics reporting site. As the ML/AI and DOE engine continues to receive data from these and/or other external sources, as well as from the client's continued interactions with the platform, updated data is transmitted to the EL server which in turn updates the content and features of the CMS/UI. The ML/AI engine collects and indexes client behavior on an ongoing basis. As the engine “learns” what is relevant to the specific client, it continually tailors that client's UI to meet his or her specific needs and interests.

In accordance with various aspects described herein, systems for self-directed investing may be improved by deciphering and educating clients. User interfaces may be improved by providing a conversational and narrative interface that provides the most relevant information to an individual and in a format which the client may best utilize, as determined by the client's previous interactions with the platform. For example, if a client frequently interacts with tools but generally does not read suggested articles, tools may be prioritized over articles within that particular client's user interface.

In some aspects, known and continually learned client data is used to create tailored client experiences. Through client interactions, design of experiment, and data driven segment discovery, a firm may be able continually optimize its clients' digital experience. The resulting benefits may include higher levels of customer satisfaction, improved attrition, increased revenue, and increased cross-channel opportunities. The principles of predictive technology may be used to leverage existing client data, as well as data that is continuously collected, to create an engine that delivers timely and personally optimized experiences for clients. Proactively presenting such personally relevant and meaningful content also may increase overall client engagement, leading to more frequent logins, increased use of tools, increased trading, and increased wallet share. The improved platform also may help advance broader initiatives that look at portfolio management through the lens of financial priorities, goals, and life events.

The UIs described herein may employ present natural language (e.g., eliminating jargon) and include excellent visuals throughout in order to meet the needs of primarily novice investors and increase their overall levels of engagement.

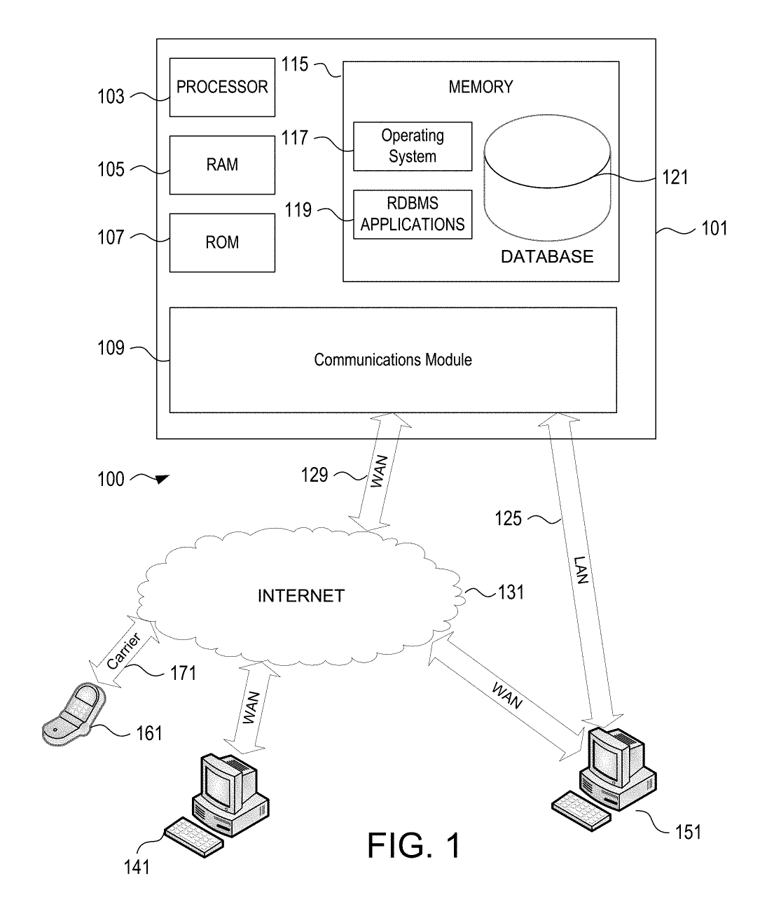

FIG. 1 illustrates an example of a suitable computing system environment 100 that may be used according to one or more illustrative embodiments. The computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts to digital files.

Although not shown, RAM 105 may include one or more are applications representing the application data stored in RAM 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling the computing device 101 to perform various functions. For example, memory 115 may store software used by the computing device 101, such as an operating system 117, application programs 119, and an associated database 121. Also, some or all of the computer executable instructions for the computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 125 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server or in Distributed Computing configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech-recognition applications.

Embodiments of the disclosure may include forms of computer-readable media. Computer-readable media include any available media that can be accessed by a computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 101. Such a processor may execute computer-executable instructions stored on a computer-readable medium.

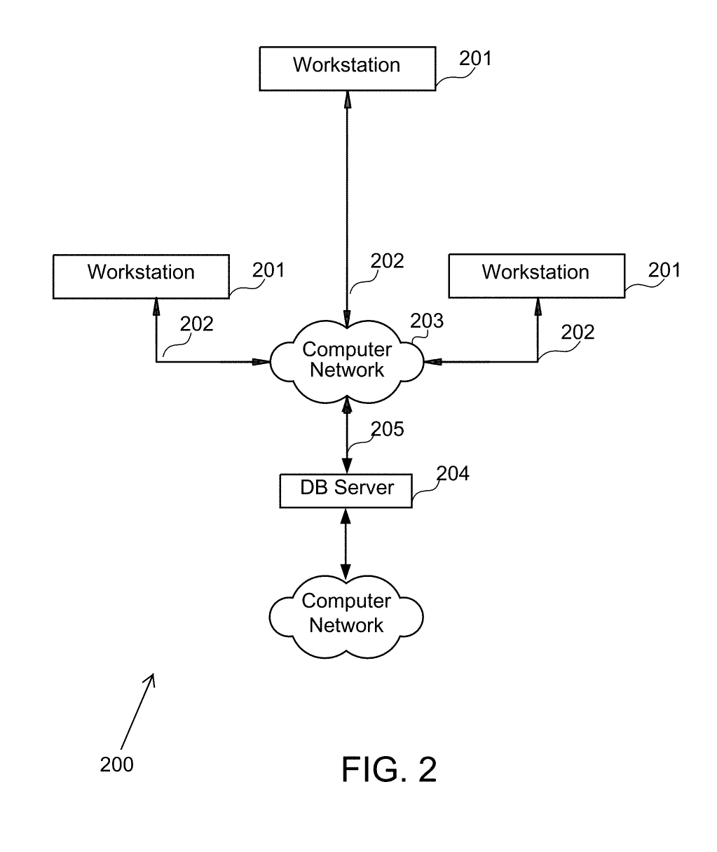

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants (clients).

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, and hard-wired links.

Database servers may serve different types of databases, including a relational database, e.g., SQL database, object-oriented databases, linear databases, self-referential databases, and other types of databases. In some embodiments, the processes executing on a database administrator's computer may support a graphical user interface (GUI) that provides on a database (DB) administrator's desktop a near real-time view of multiple SQL server instances. Because, in those embodiments, monitoring configuration is not required on a SQL server, the GUI tool may appear to be essentially instantaneous to the DB administrator so that any newly built SQL server can be viewed without having to prepare the server from monitoring standpoint (e.g., to provide a plug-and-play like functionality).

Information about the SQL Server status may be presented in a graphical user interface (GUI) format where status information for all of the listed database servers is presented in one integrated view in an automated manner. A monitoring process may read a list of SQL Server Instances from a designated Server detail repository (in form of a database) of organization or from a flat text input file and then connects to each listed SQL server to query the System Catalogs of the SQL Server engine. Because the monitoring process runs from a central server, configuration demand at the SQL server's side is circumvented. The monitoring process interprets the received information from the SQL servers and updates the GUI. By monitoring and obtaining additional information about SQL features for specified servers through the GUI, the database administrator or any other user (or self-learning analytics engine) may then report and/or fix detected issues. The processes may use a 32-bit operating system, thus circumventing a complicated monitoring infrastructure that demands extra skill sets and significant cost with infrastructure dependency.

The various steps that follow in the discussion of subsequent Figures may be implemented by one or more of the components in FIGS. 1 and 2 and/or other components, including other computing devices.

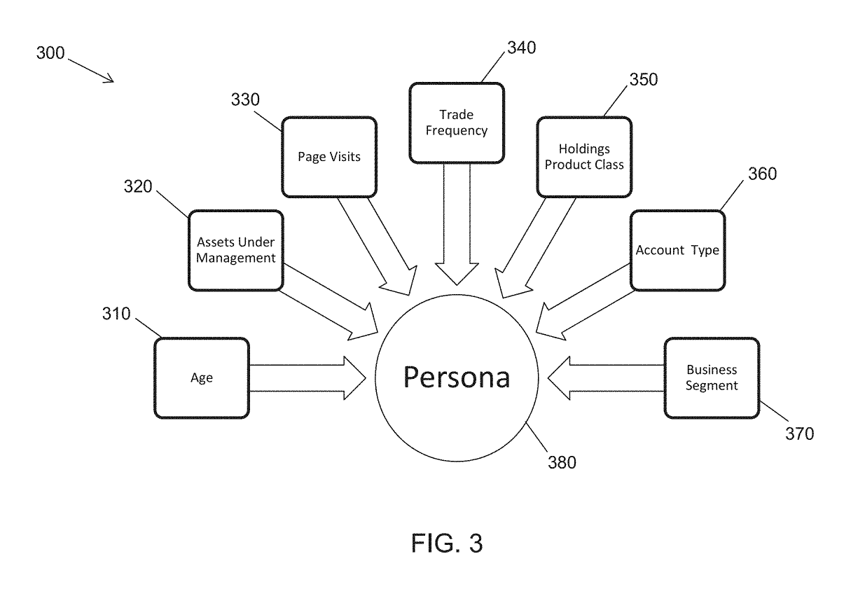

FIG. 3 schematically illustrates online personalization and segmentation 300. Online personalization is a process that is used to create relevant, individualized interactions between a client and an online experience. It leverages insight based on the client's known personal and behavioral data to deliver an experience that meets his or her specific needs and preferences. By analyzing client demographics and behaviors, clients with similar behaviors may be grouped into baseline digital persona profiles 380. The digital persona profiles may be selected from a small number of predetermined categories of inventors, such as “disengaged,” “passive,” “engaged,” and “active trader.” Examples of data that may define a client's digital persona profile 380 include age 310, assets under management (AUM) 320, page visits 330, trade frequency 340, holdings by product class 350, account type 360, and business segment 370. Other non-limiting examples of factors defining the persona may include transfer frequency, online login frequency, mobile login frequency, online banking login frequency, and days since account opening.

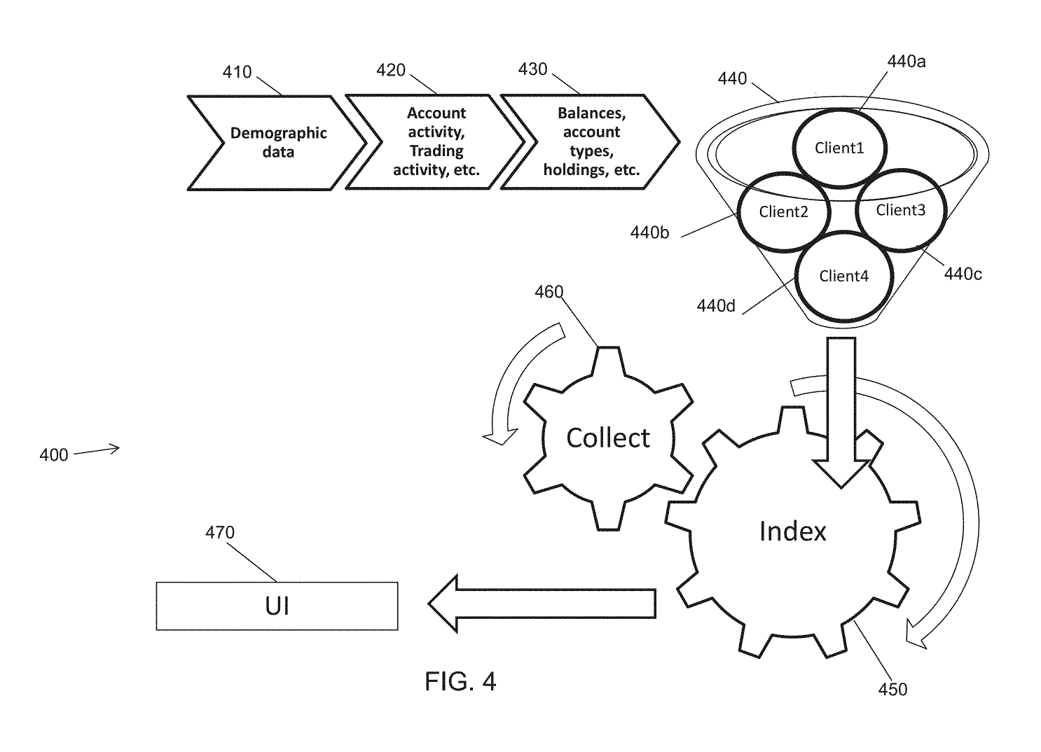

FIG. 4 is an overview of an event sequence 400 in accordance with some aspects. Clients' demographic data 410, account activity 420, and account information 430 are collected for a set 400 of individual clients 440a, 440b, 440c, 440d. Based on the information gathered, the individual clients are initially indexed 450 into one of the four categories of investor personas described above. Based on the personas, user interfaces for these individual clients 440a, 440b, 440c, 440d are appropriately tailored. For example, for a “passive” investor persona, the UI 470 may include more basic information concerning a particular investment, whereas for an “active trader” persona, the UI 470 may omit basic information and instead provide more data and market analysis relating to the client's investments. As the client continues to interact with the UI 470, additional data is collected 460 and indexed 450. As this process continues, the UI 470 is continually personalized with content that is most relevant and presented in a form most that is most useful for that client.

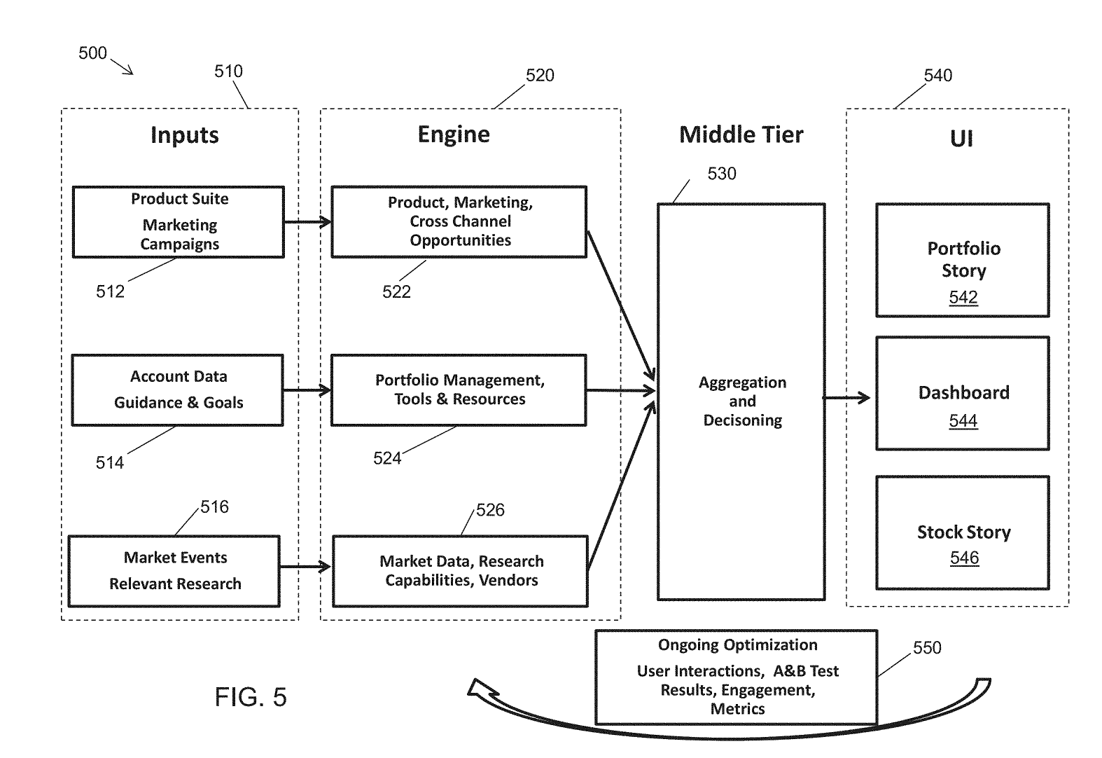

FIG. 5 shows an example of an event sequence 500 broken down by inputs 510, engines 520, a middle tier 530 for aggregating the collective data, and user interfaces 540. In addition to account data 514 and other client-specific information, content may be inputted from one or more additional sources such as marketing campaigns 512 and market events/research 516 into respective engines 524, 522, 526 for processing the data. Marketing data may be analyzed by engine 522 to identify potential cross channel opportunities for the client, for example. Market events and research materials may be analyzed by engine 526 to identify specific data or features that may be of interest to the client. The account data and other client information may be analyzed by engine 524 to determine which available features and tools may be most suitable for the client. The output of engines 522, 524, and 526 is then aggregated by a secondary engine 530 to customize the user interface 540 for the individual client. User interactions and other available data 550, such as results of testing or statistical analyses, may be collected and fed into engine 520 to enable further optimizations.

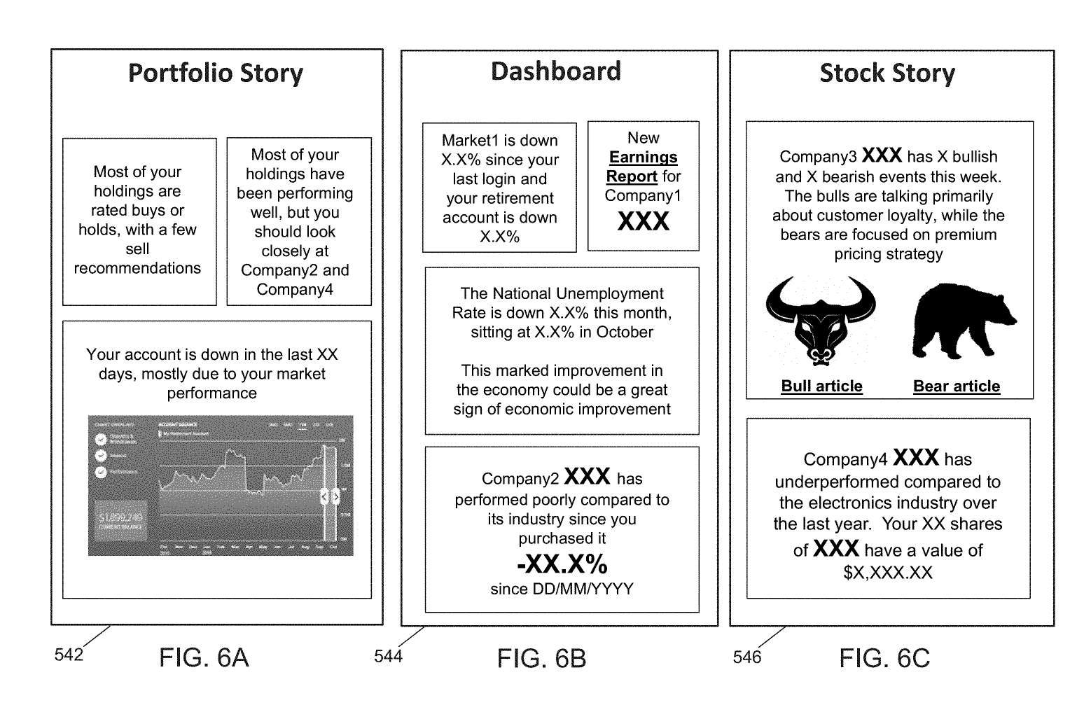

The user interface 540 may include a plurality of subcomponents, which will be referred to herein as portfolio story 542, dashboard 544, and stock story 546, and described in greater detail below with reference to FIGS. 6A-6C.

### Portfolio Story

With reference to FIG. 6A, the portfolio story 542 component of the UI guides clients with a personalized way to view and understand their portfolio. After working with this tool, investors will gain valuable insights and may be prompted to adjust their investing strategy if needed. The portfolio story 542 also may provide clients with a coherent narrative for their portfolio in a linear, “story” format with charts and explanations. This may be particularly beneficial for investors who do not wish to search for relevant information but prefer a more guided, visual experience through their portfolio.

Self-directed investors may look at a number of factors at which an investment advisor would look. For example, portfolio performance is one important factor that often does not get checked when clients review their accounts. Other indicia that may be included within the portfolio story 542 are, for example, the client's tax situation, asset allocation, and market exposure. Portfolio story 542 may function to instruct a client what he or she needs to look at in a step-by-step, narrative fashion. FIG. 6A shows examples of screen shots showing different “chapters” of the portfolio story 542. The first chapter may present the portfolio's overall performance in a past time interval, e.g., 30 days, or since the client's last login. As shown in FIG. 6A, the text may be included in question-and-answer format to help educate the client with respect to questions that should be asked. The first “chapter” of the portfolio story 542 may include the question, “How's my portfolio performing?” and the answer, “Your account is down in the last 30 days, mostly due to your market performance” or “mostly due to a withdrawal you made from the account,” for example. Similar question-and-answer narratives may be provided for other “chapters” of the portfolio story 542.

Brokerage firm databases typically contain a large library of articles, many of which are rarely accessed by investors. The portfolio story 542 interface also may help educate investors by suggesting relevant articles at appropriate times. For example, if a client's asset allocation is inappropriate in view of existing market conditions, the narrative in the asset allocation chapter may alert the client to this fact and direct the client to a relevant article, e.g., “here's an article explaining how to reallocate assets when markets are off,” along with a hyperlink to the article. Each chapter may conclude with one or more suggested actions, if applicable, for the particular topic, along with hyperlinks or other tools to assist the client in implementing the suggested action. The portfolio story 542, in short, may help educate a client in how to be his or her own financial advisor.

### Dashboard

With reference to FIG. 6B, the dashboard 544 component of the UI 540 highlights high-level information that dynamically reacts to a client's preferences, past digital interactions, and changes in the market and/or to the client's portfolio. Unlike a traditional dashboard, the content is optimized and is not constrained by a static layout. Content appearing in the dashboard 544 may be ranked by both relevancy and timeliness. The dashboard 544 aims to increase investor engagement and drive idea-generation by identifying timely opportunities to take action. It may provide “jumping-off points” that help investors make informed investment decisions using a series of tailored tiles.

The dashboard 544 may help a client identify new opportunities and decide what action to take next. A list of content may be prioritized based on how the client interacted with the platform in the past as well as to prioritize any “big” news stories for the day. If a client's interaction with the platform involves frequently reviewing fixed income securities, for example, a recent article about fixed income securities may be assigned a higher priority for display in the dashboard 544. The content presented in the dashboard 544 may dynamically evolve as market conditions change and new content becomes available. If a client logins in at 9:00 a.m. and then returns at 11:00 a.m., the dashboard 544 may look completely different.

Content presented in the dashboard 544 may provide the client an opportunity to obtain additional information on a topic, e.g., a hyperlink to the full text of an article, or to select an option “not interested.” If a client indicates he or she is not interested in a topic, the UI may ask a follow-up question, such as “why not?” to assist the machine-learning process. A client who indicates he or she is not interested in the topic may be prompted to select from several choices identifying a reason for the lack of interest. For example, choices may include “not interested in this particular company,” “not interested in the energy sector,” or “not interested in market movements.” The client's response may be used to further personalize the dashboard 544. In general, the more a client interacts with the UI 540, the more it will become personalized for that individual.

The various dashboard tiles presented may be aligned with the client's individual persona. The dashboard tiles presented on the dashboard 544 may be selected from a large inventory of tiles in order to display information that is relevant to the client's overall situation, unique to current market conditions, and personalized based on how the current market conditions may be effecting the client's portfolio. The overall user experience may be aligned to the client's persona on an initial login and thereafter customized based on the client's preferences learned through ongoing interaction.

The following is an example of a scenario when a client accesses the dashboard 544 component of the UI. The dashboard 544 may recognize that (i) the market is open; (ii) the client last logged in three months ago; (iii) above average sector performance swings have resulted in a greater portfolio percent change; and (iv) large trades have been processed during this time. Based on this information, the dashboard may show tiles for (1) open market indices; (2) market sentiment; (3) sector overview; (4) portfolio performance; and (5) recent trades tiles. All of the changes in the performance shown in tiles may be relative to three months ago, based on when the client last logged in, for added relevancy to the client's personal situation.

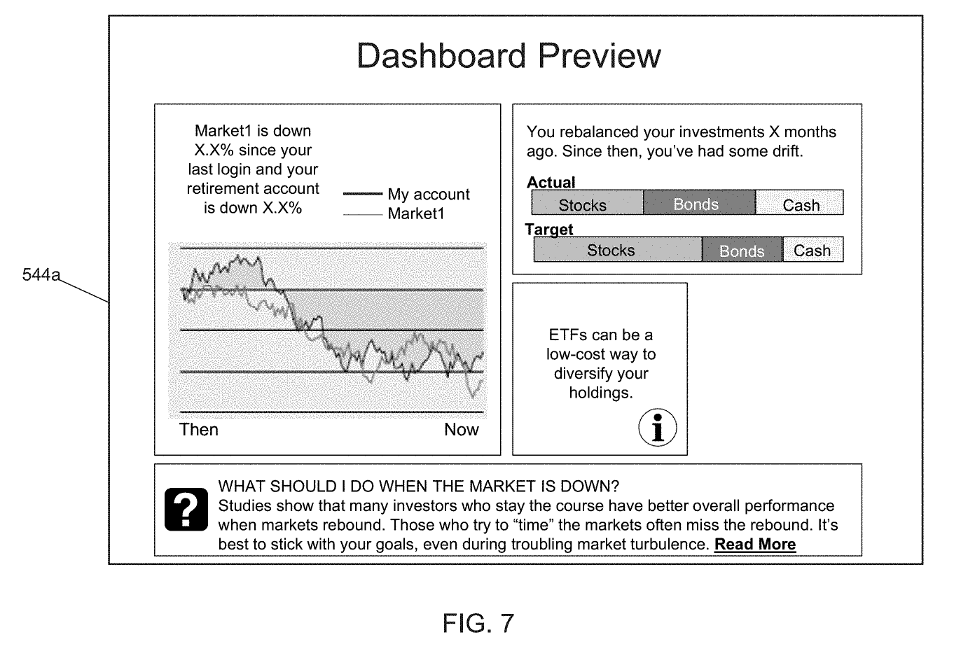

FIG. 7 shows an example of a “day one” dashboard preview 544a. The dashboard displays a first tile that the engine deems to be of most relevance to the client, for example, a tile showing overall market performance and portfolio performance since the client's last login, as illustrated in FIG. 7. Other tiles may highlight other key characteristics or changes to the client's portfolio (e.g., rebalancing of assets, as shown in FIG. 7) and include a narrative with any applicable suggestions. The client may click on a tile to obtain additional information and materials, or may scroll down the page to see additional tiles.

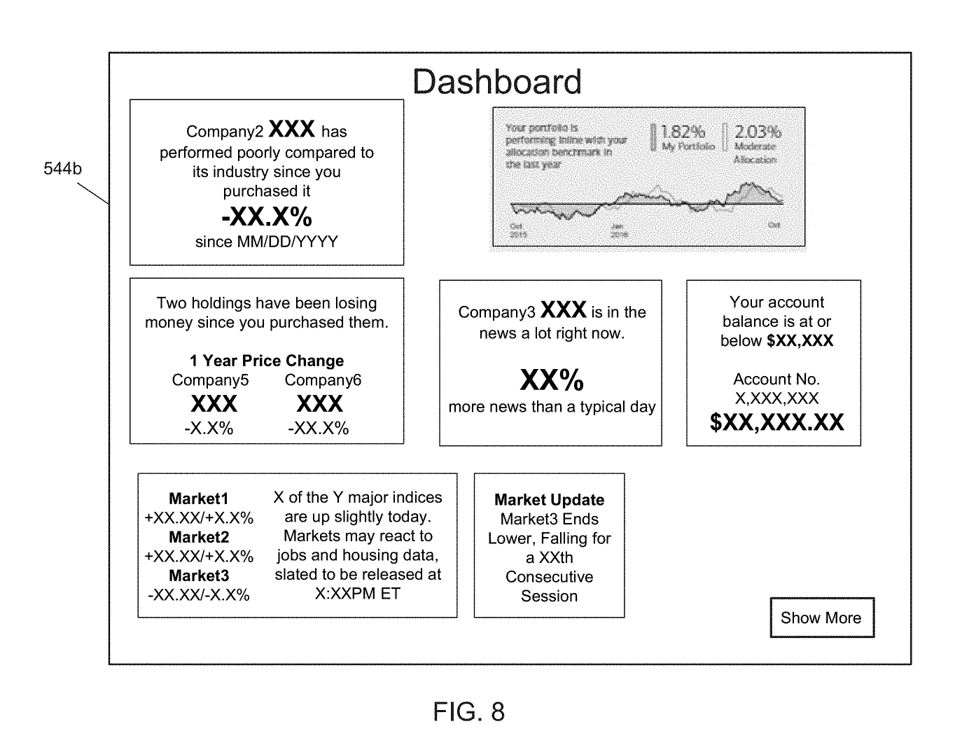

The dashboard tiles initially may appear in a collapsed state. When a tile is selected, it may transform into an expanded state which contains additional details pertaining to the selected content. As shown at the bottom right of FIG. 8, the client also may select an option “show more” to load additional tiles containing related content. The dashboard also may contain additional buttons (not illustrated) that allow the client to select preferences, e.g., request that the dashboard 544 show more or fewer opportunities, portfolio strategy, news events, guidance, and the like, in order to assist the UI customization and machine learning process.

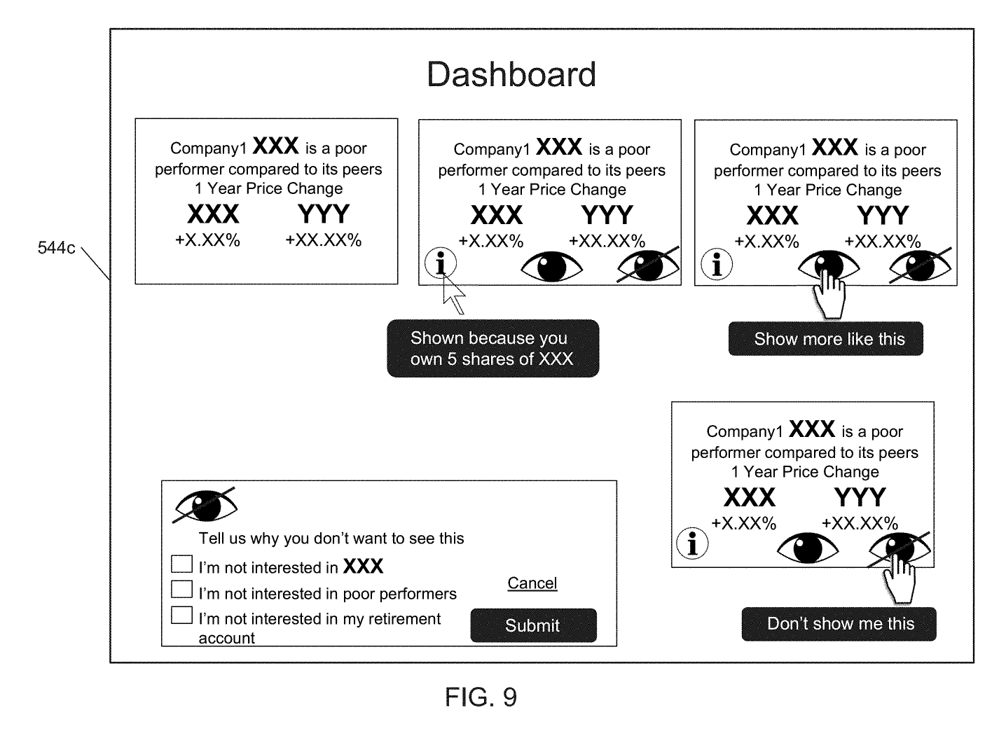

FIG. 9 shows a series of dashboard tiles 544c containing icons to provide additional explanation and/or to capture a client's preferences. When a tile is initially displayed, as depicted in the upper left of FIG. 9, it may contain no icons in order to minimize visual noise. As shown in the tile immediately to the right thereof, when the client positions the mouse pointer over the tile, the icons are revealed in the bottom portion of the tile. When a client hovers over the “information” icon (bottom left of the tiles shown in FIG. 9), a popup with text appears explaining why the particular tile is being displayed, e.g., “Shown because you own X shares of XXX,” as depicted in the top center tile shown in FIG. 9. At the lower right portion of the tiles as shown in FIG. 9, additional icons for “show more” and “don't show” allow the client to request the dashboard 544 to show more or fewer tiles like the one being viewed, respectively.

As illustrated in the tile depicted in the upper right of FIG. 9, when the client hovers over the “show more” icon, a popup with text appears explaining the purpose of the icon, e.g., “Show more like this.” If the client clicks on the “show more” icon, a message may appear confirming the client's selection and giving the client the option to undo the action. If the client clicks the “don't show” icon, he or she may be prompted to select a reason for not wanting to see the particular tile. As illustrated in the bottom left of FIG. 9, the choices for the response may include a lack of interest in the company/stock, a lack of interest in the particular type of market movement, a lack of interest in his or her retirement account, and/or other reason(s) that the tile appeared in the dashboard.

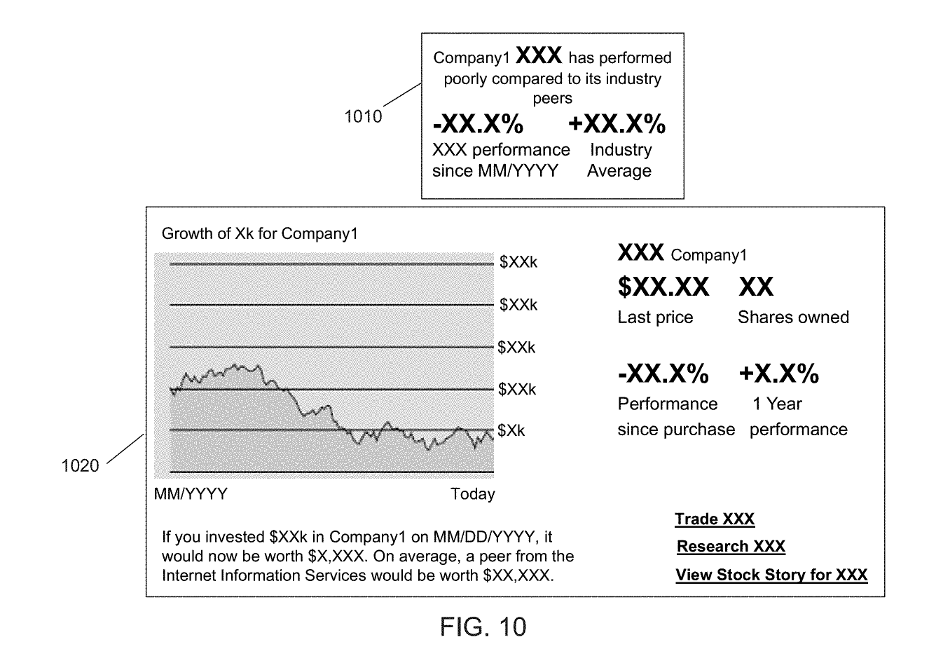

FIG. 10 shows an example of a dashboard tile in both a collapsed state 1010 and an expanded state 1020. While in the collapsed state 1010, the tile may contain a simple personalized message, e.g., “Company1 has performed poorly compared to its industry peers,” along with data showing the stock's performance compared to the industry average since the time of purchase. When the client clicks on the collapsed tile 1010, it transforms into an expanded state 1020 that includes additional information, such as a chart showing the stock's value over time since its purchase, the current trading price, the number of shares owned, and performance over the past year. The expanded tile 1020 also may include a personalized message, e.g., explaining how an investment of a specific amount would have fared for the particular stock and how it would have fared on average for other companies in the same industry. The bottom of the expanded tile also may include additional options, such as buying or selling shares of the stock, researching the stock, or viewing the stock story 546 for the company.

### Stock Story

With reference to FIG. 6C, the stock story 546 component of the UI 540 provides relevant and customized information to a client who is researching a particular stock/company. Stock story 546 may provide investors with coherent content in a flowing story format with highly visual data displays. A goal of stock story 546 is to piece together a meaningful, concise narrative from the massive amounts of data and content available for researching a stock. The information displayed in stock story 546 is highly dynamic, as it is influenced by news/events relating to the company and its stock performance, as well as developments effecting the broader industry sectors and markets.

Stock story 546 generally involves a lower extent of client-based customization than is involved in portfolio story 542 or dashboard 544, simply because the substantive information about a company or its stock does not vary from one client to the next. Customization of the stock story 546 instead may be based on the client's relationship with the stock/company. A client's relationship with a stock/company generally may be categorized as one of five possibilities: 1) first time checking on the stock; 2) already own the stock in a mutual fund or ETF; 3) already own the stock directly; 4) previously checked on the stock and now checking on it again; and 5) previously owned the stock and now checking on it again.

If the client presently owns a stock, the first item displayed in stock story 546 may be the stock's performance. This display may indicate how well the stock has performed, for example, since the client purchased the stock and/or since the client last visited the site. If, on the other hand, a client is researching a stock/company for the first time, the first item displayed on the stock story interface 546 may include basic information about the company, e.g., nature of their business and industry, and the like. As with the dashboard 544, the stock story interface 546 also may include a “checkout” option for the client to purchase or sell shares of the stock being reviewed. Other customizations to the stock story interface 546 may be made depending on the client's past relationships with the stock.

The engine supporting the stock story interface 546 may process data from dozens of news sources and provide a summary that is most relevant to the client. From the client's standpoint, instead of taking 4-5 hours to digest all of this content, a concise summary may be provided in the stock story 546 that can be digested in a few minutes. In view of these significant efficiencies, the stock story interface 546 may be helpful even to an investment professional.

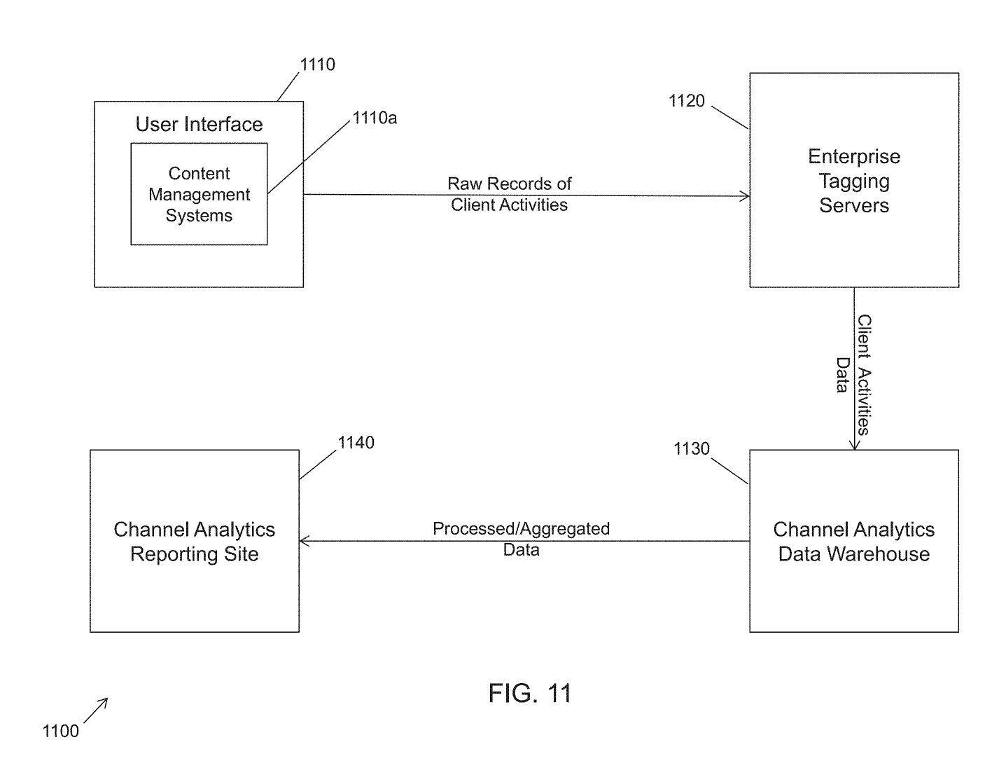

FIG. 11 is a schematic overview of an enterprise tagging (ET) system 1100. A user interface (UI) 1110 presents content to a client. A content management system (CMS) 1110a supports the UI 1110 and can dynamically change the content and images presented on the UI 1110. The enterprise tagging (ET) servers 1120 receive raw records of the client's digital activities. The raw records are processed by the ET servers 1120 are then sent to a channel analytics data warehouse (CADW) 1130. The CADW 1130 processes, aggregates, and stores the client's activities for purposes of reporting and analytics. The CADW 1130 also may process feeds from other data systems (not illustrated). The processed and aggregated data is then fed to a channel analytics reporting site (CARS) 1140, which hosts customized reports and analytics. From the CARS 1140, clients may request and generate reports interactively.

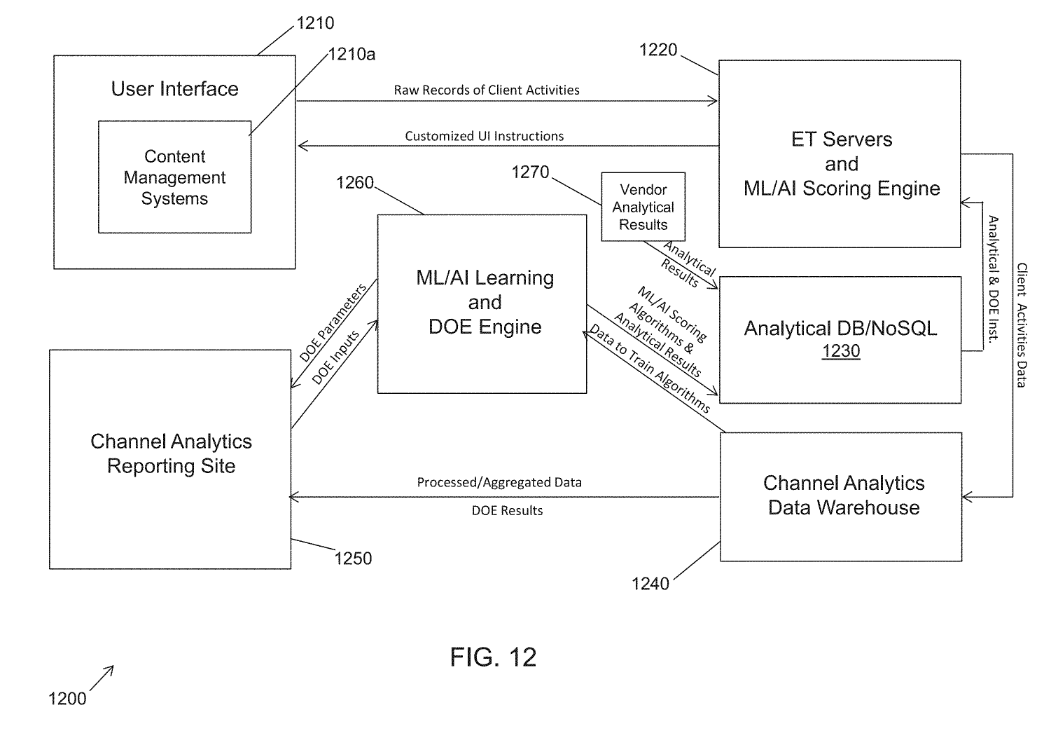

FIG. 12 is a schematic illustration of a machine learning/artificial intelligence (ML/AI) system 1200 that may be used in accordance with various aspects disclosed herein. A CMS 1210a (or other dynamic UI system) reads UI instructions to generate a customized UI 1210. The ET servers 1220 receive the raw records of the client's digital activities and also feature a ML/AI scoring engine which processes the raw records of the client's digital activities to generate customized UI instructions, which are fed back to the CMS 1210a/UI 1210. In addition to reading and processing ET records, the ET servers 1220 may fetch analytical results, run real-time analytical functions, and generate UI instructions. The raw records of client activities also are fed from the ET server 1220 to the CADW 1240. The CADW 1240 is a software framework for storing data that allows multiple data sources to be integrated using efficient data platforms. As illustrated in FIG. 12, data from the CADW also is fed to a ML/AI and DOE engine 1260. Two key components included in the channel analytics reporting site (CARS) 1250 are (i) DOE interfaces for businesses to set up and review DOE results and (ii) AI interfaces to show algorithm details.

The ML/AI engine 1260 may support advanced ML/AI and design of experiment (DOE) capabilities. The AI learning engine 1260 learns client patterns and preferences by AI algorithms. It also supports DOE setup and analysis. An analytical structured storage (DB/NoSQL) 1230 saves the batch processed AI results for fast responses. It also saves AI scoring libraries. DOE results and setups, and vendor analytical results 1270 may be saved in the analytical structured storage 1230 as well.

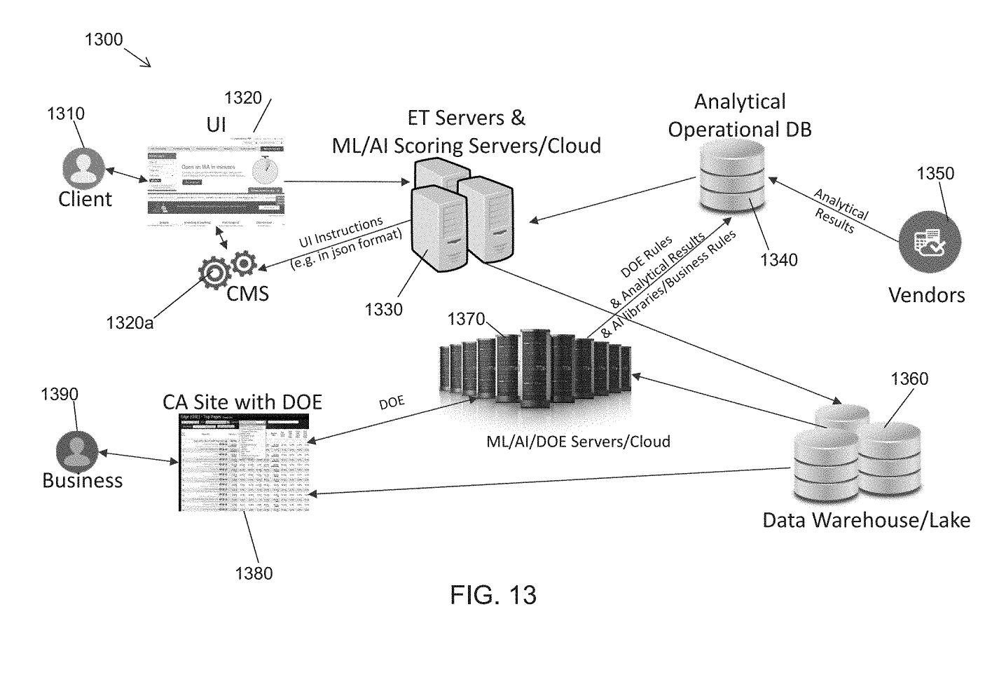

FIG. 13 shows an example of a system 1300 that may provide a cost-effective way to provide advanced real-time AI capabilities. Beyond most existing ML/AI systems, the system design illustrated in FIG. 13 enables two key advanced features: 1) integrating DOE with ML/AI and 2) supporting multi-layer ML/AI and business rules integration. As illustrated in FIG. 13, a client 1310 interacts with UI 1320 which is initially customized by CMS 1320a. The ET servers 1330 receive the raw records of the client's digital activities and also feature a ML/AI scoring server which processes the raw records of the client's digital activities to generate customized UI instructions, which are fed back to the CMS 1320a. The ET servers 1330 also receive analytical results from an analytical operational database 1340, which in turn receives analytical results from vendors 1350 and also DOE rules and analytical results from ML/AI/DOE servers 1370. Data from the ET servers 1330 also is fed to a data warehouse/lake 1360.

Business rules integration may be achieved by a business user 1390 interacting with a channel analytics (CA) site 1380 featuring DOE functionality. The CA site 1380 also receives data from the data warehouse/lake 1360, as shown in FIG. 13. The CA site 1380 shares DOE instructions with the ML/AI/DOE server 1370; and DOE rules and analytical results are fed to the analytical operational DB 1340.

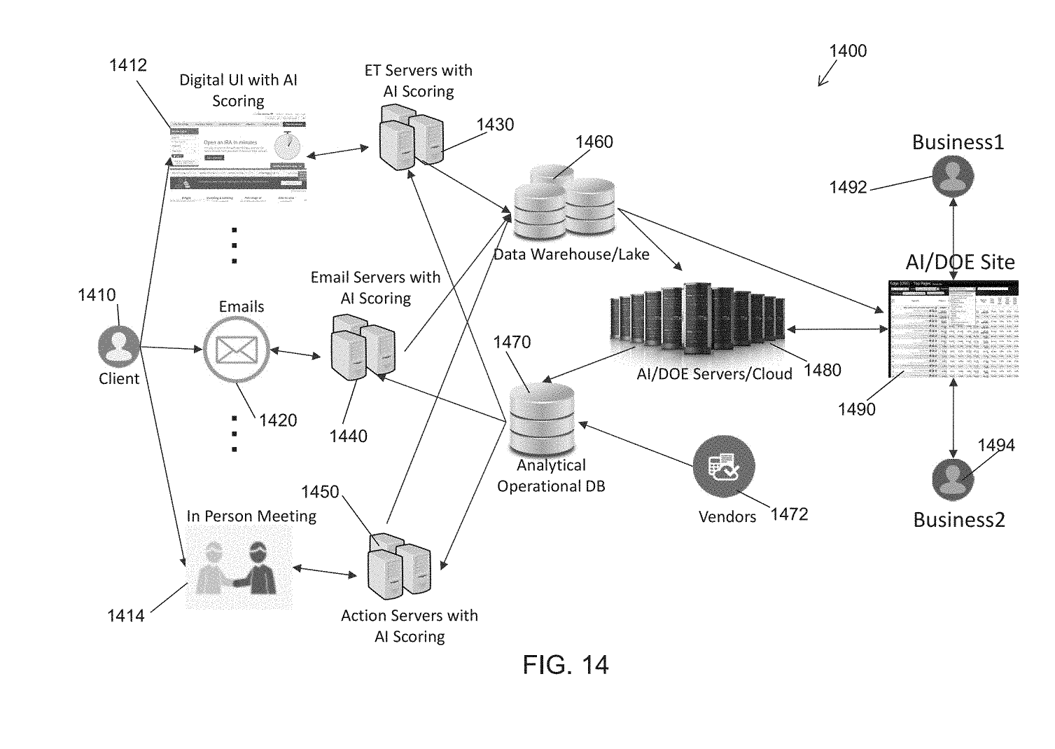

FIG. 14 shows an example of an alternative system design 1400 which can support Omni-channel analytics. In this configuration, a client may interact with UI 1412 and/or with the firm in person 1414 and/or by e-mail 1420. Data from such interactions are fed to ET servers 1430, e-mail servers 1440, and action servers 1450, respectively, each of which features AI scoring functionality and each of which in turn feeds data to a data warehouse/lake 1460. Data from the data warehouse/lake 1460 is transferred to AI/DOE servers 1480, which communicates with an analytical operational DB 1470. The analytical operational DB 1470 also receives data from vendors 1472 and sends instructions back to the ET servers 1430, email servers 1440, and action servers 1450.

Business rules integration may be implemented by having business users 1492, 1494 interact with an AI site 1490 that features DOE functionality. The AI site 1490 also receives data from the data warehouse/lake 1460, as shown in FIG. 14. The AI site 1490 shares DOE instructions with the AI/DOE servers 1480; and DOE rules and analytical results are fed to the analytical operational DB 1470.

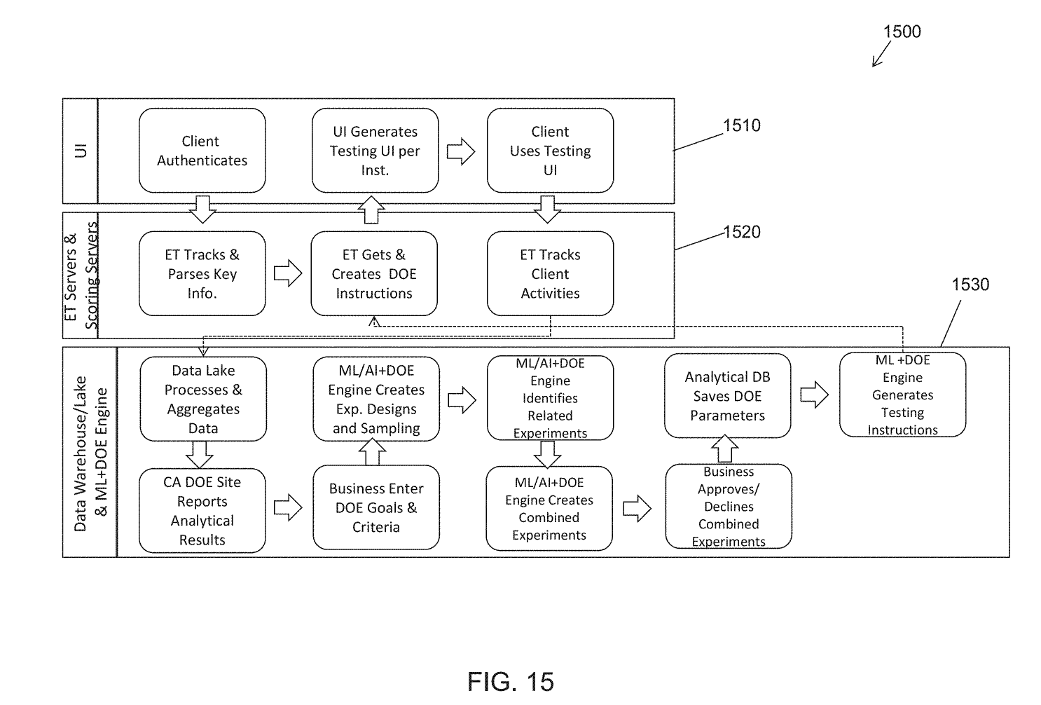

FIG. 15 is a schematic illustration of a “phase one” system 1500 that may be used to develop batch processed (non-real time) personalization analytics. FIG. 15 shows different steps for and the flow of steps between the UI 1510, ET servers 1520, and data warehouse/lake and ML/DOE engine 1530. The wider arrows with solid lines in FIGS. 15-18 indicate process flow and the narrower arrows with dashed lines indicate data flow.

With reference to the bottom left-center of FIG. 15, a business initially may input DOE goals and criteria within the data warehouse/lake 1530. Based on these goals and criteria, the ML/AI/DOE engine 1530 may create experimental designs and sampling. The ML/AI/DOE engine 1530 then may identify any related experiments and create combined experiments when applicable. Meanwhile the ET server 1520 retrieves and creates DOE instructions, and a testing UI 1510 is generated per the instructions. A client uses the testing UI 1510, and the ET server 1520 tracks the client's activities. Data is then transmitted from the ET server 1520 to the data warehouse/lake 1530. The channel analytics DOE site then may track and report the testing results. If the business selects the results per statistical tests, the strategy may be deployed automatically (or approved) for an entire client population.

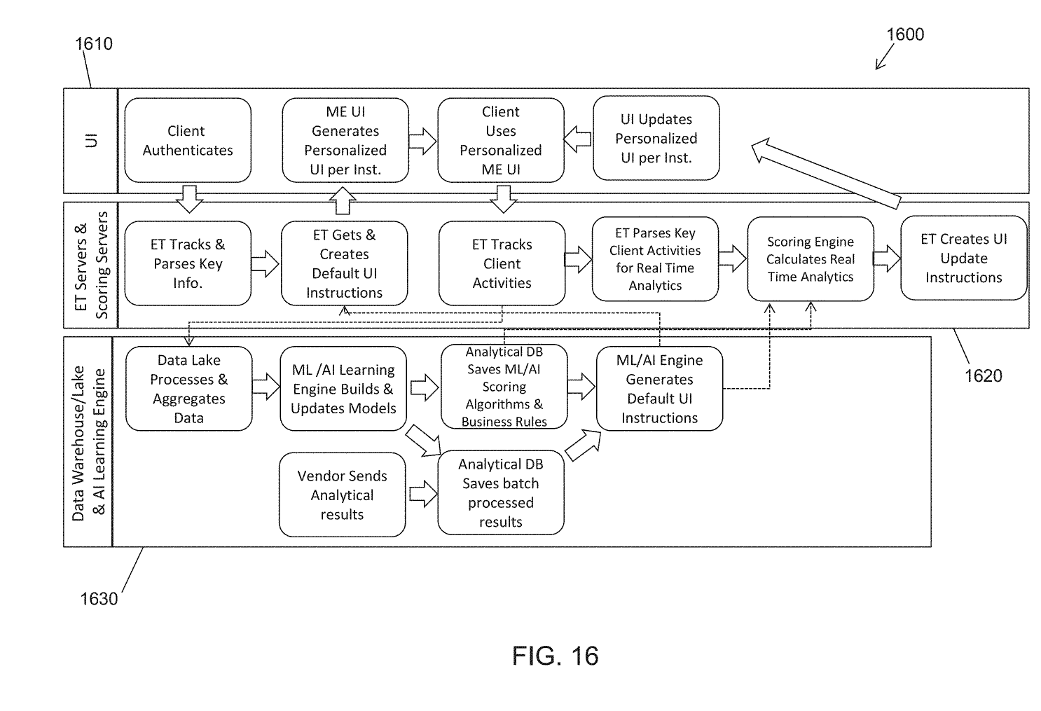

FIG. 16 is an example of a “phase two” system 1600 that supports real-time multi-layer personalization analytics. This system involves a similar process flow for the UI 1610, ET servers 1620, and data warehouse/lake and ML/DOE engine 1630 as described above in connection with FIG. 15. The differences with the “phase two” system 1600 are that the ET servers 1620 parse key client activities for real time analytics; a scoring engine calculates real time analytics; and the ET servers 1620 create updated UI instructions. The UI 1610 then updates the personalized UI per those instructions.

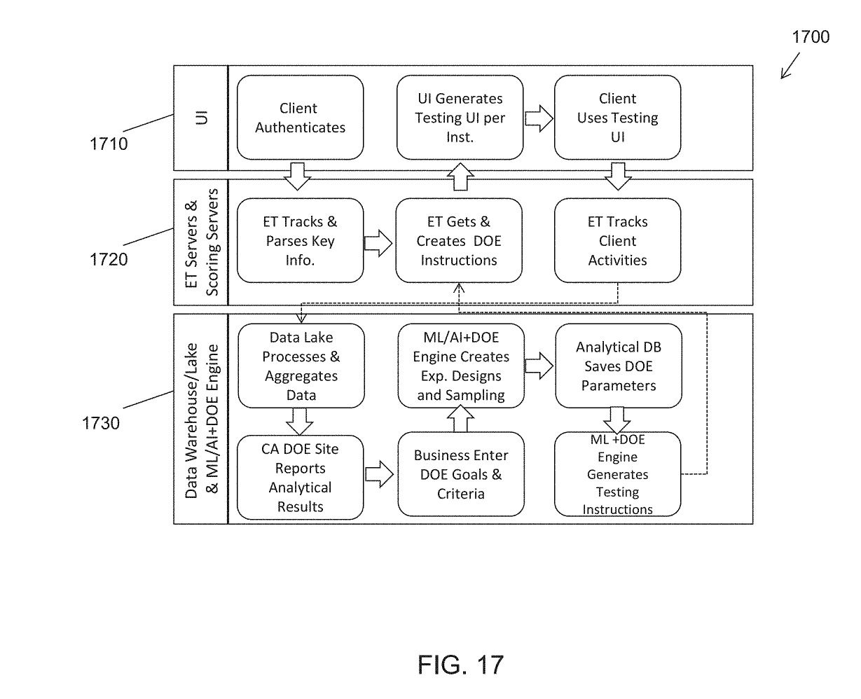

FIG. 17 shows an example of a system 1700 that may support individual design of experiments including AB testing and multivariate testing. The wider arrows shown in FIG. 17 indicate process flow and the narrower arrows indicate data flow. Within the data warehouse/lake 1730 framework, the business may input DOE goals and criteria, as illustrated in the bottom center portion of FIG. 17. For example, one goal may be to test new navigation flow and themes. Success metrics may be defined, for example, as a new account opening. Next, the ML/AI/DOE engine 1730 may create experimental designs and sampling. Based on historical data, the ML/AI/DOE engine may identify blocking factors, such as age and AUM.

The ML/AI/DOE engine 1730 then may create factorial designs with sampled client IDs for testing. Meanwhile the ET server 1720 retrieves and creates DOE instructions, and a testing UI 1710 is generated per the instructions. A client uses the testing UI 1710, and the ET server 1720 tracks the client's activities. Data is then transmitted from the ET server 1720 to the data warehouse/lake 1730. The channel analytics DOE site then may track and report the testing results. If the business selects the results per statistical tests, the strategy may be deployed automatically (or approved) for an entire client population.

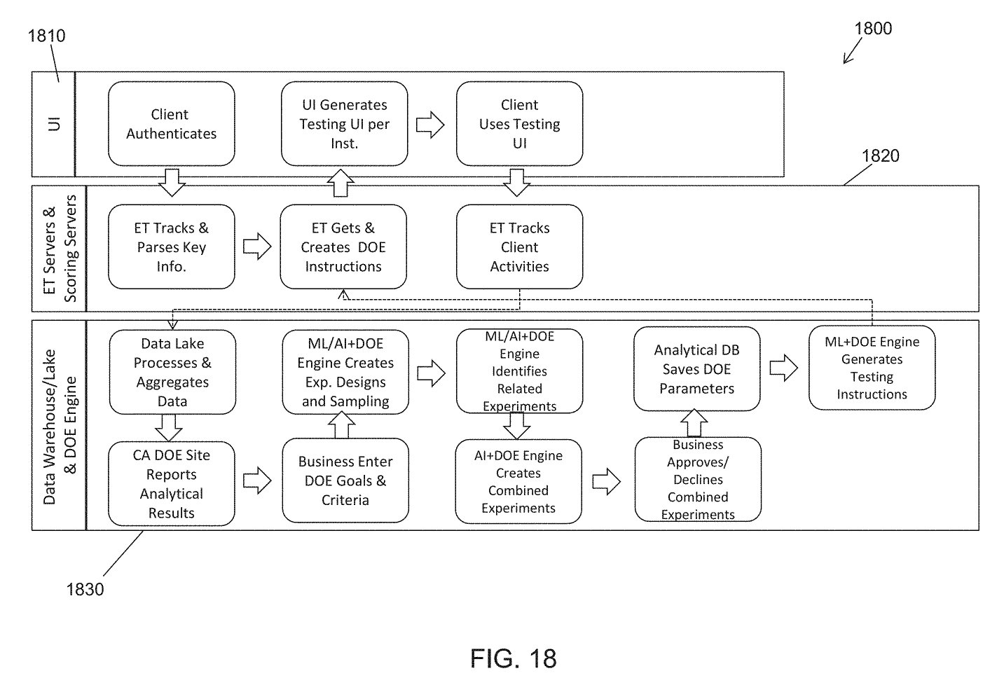

FIG. 18 shows an example of a system 1800 that may coordinate multiple experiments from different business partners. The system 1800 is similar as was previously described in FIG. 17 with reference to the UI 1810, ET servers 1820, and data warehouse/lake 1830. The clustering engine seeks to segment clients based on their behaviors. This system 1800 may be used to create and update default experiences, recommend high level content groups, continuously identify opportunities to improve client experiences, analyze and quantify client behavior, group clients with similar behaviors, and profile each grouping into a cluster.

Clustering algorithms that analyze client portal usage patterns to determine personas allow for a more consistent look at usage patterns while controlling for seasonal and infrequent activities. The resulting personas not only allow for more in-depth understanding of clients' usage patterns, but also provide predictive insight into future usage patterns. Persona profile reporting may provide demographic, account, and holding information of each persona. Success metrics reporting may be used to provide key performance metrics by personas and correlation analysis. Detail reporting may provide a comprehensive view of all the metrics for a selected persona. Feature usage reporting shows digital usage by personas, on the grouped feature level. Finally, page usage reporting may be used to show digital usage by personas, on the detailed URL level.

N-gram modeling may be applied to compute the likelihood of persona changes. This modeling can answer the following two questions: (1) given a current persona “A,” what's the likelihood of having persona “B” in the future? (2) given a current persona C, what's the likelihood that the client had persona D in the past? This modeling is not only helpful to describe what happened, but also useful to predict future personas of clients.

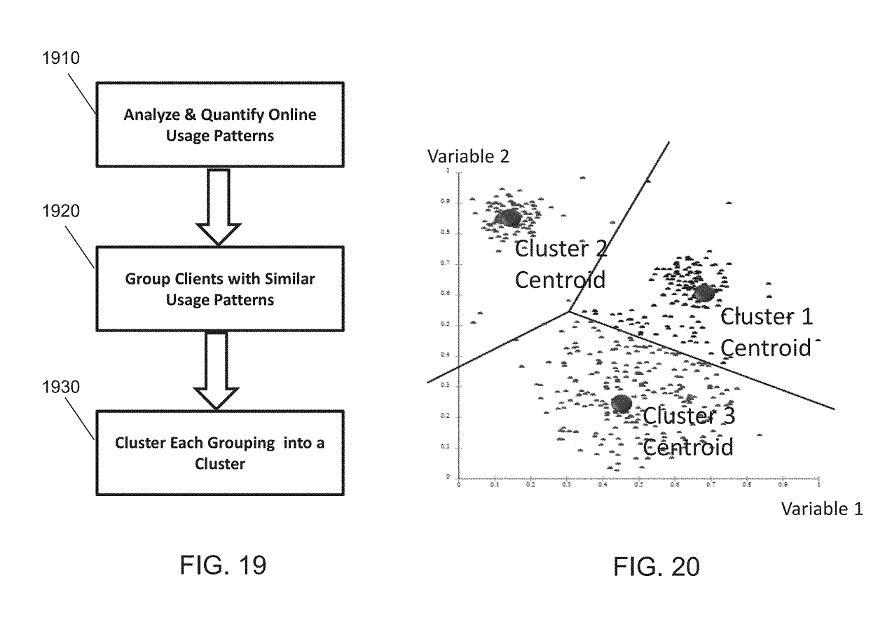

FIG. 19 shows an overview for updating personalized UI instructions using clustering analysis. Clustering analysis may be applied to group clients with similar digital activities or usage patterns forming profiles into personas. Given the enormous volume of online content and breadth of online interactions, getting a clear picture of a client's “typical” digital usage patterns is challenging. Analyzing overall site trends hides visitor usage patterns stories. This technique essentially involves analyzing and quantifying online usage patterns 1910, grouping clients with similar usage patterns 1920, and then clustering each grouping into a cluster 1930.

FIG. 20 illustrates a clustering methodology using K-mean clustering steps, in which clients are assigned to multiple clusters using fuzzy clustering with a similarity threshold. Fuzzy clustering reduces the possible modeling error and data noise. The similarity threshold provides a good balance between model accuracy and usefulness. A client's primary cluster is assigned by ranking clusters with the business knowledge. For a client with multiple clusters, the primary cluster may be chosen by business interest. A deeper analysis may be performed on clients who change clusters.

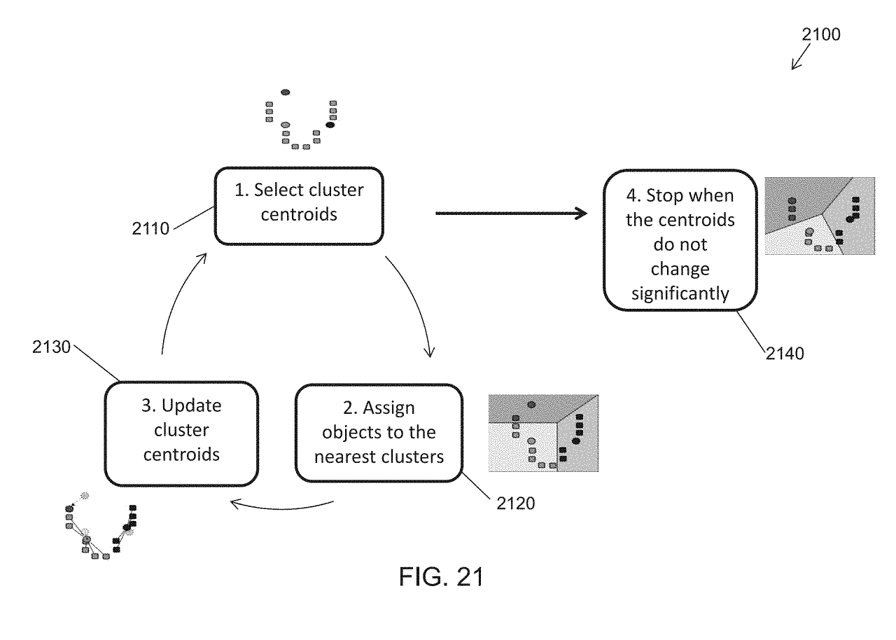

FIG. 21 shows sequential steps which may be implemented to assign objects to clusters. Clustering performance may be monitored with variance charts. Cluster characters may be defined, and variables determined by which to measure objects. Once the number of clusters is defined, clustering algorithms may be run to identify cluster centroids 2110. Each cluster is defined by the location of the centroid. Each object is then assigned to the nearest cluster 2120. The object then is measured vis-à-vis the defined variables and the distance between the object and each cluster centroid is calculated. Based on this distance, the cluster centroids are updated 2130. This process is repeated until the centroids do not change significantly 2140.

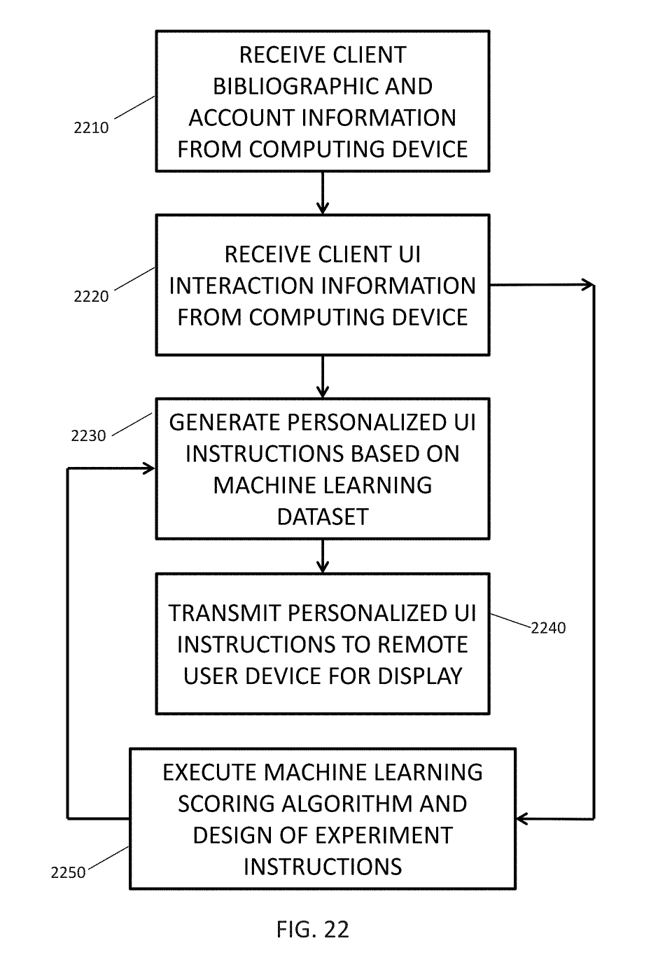

FIG. 22 depicts an illustrative method for generating personalized user interface instructions and transmitting to a remote client device for display in accordance with one or more example embodiments. At step 2210, a first content stream containing client bibliographic information and account information is received by a processor of a computing platform via a communication interface from a content management system. At step 2220, a second content stream containing data of client interactions with a user interface is received via the communication interface from an enterprise tagging server. Personalized user interface instructions then are generated 2330 based on a machine learning dataset. The personalized user interface instructions are transmitted 2240 to a remote client device for display thereon. Subsequent client user interface interaction data 2220 may be analyzed using machine learning scoring algorithms and/or design of experiment instructions to update the personalized user interface instructions 2230 for transmission to the remote client device 2240.

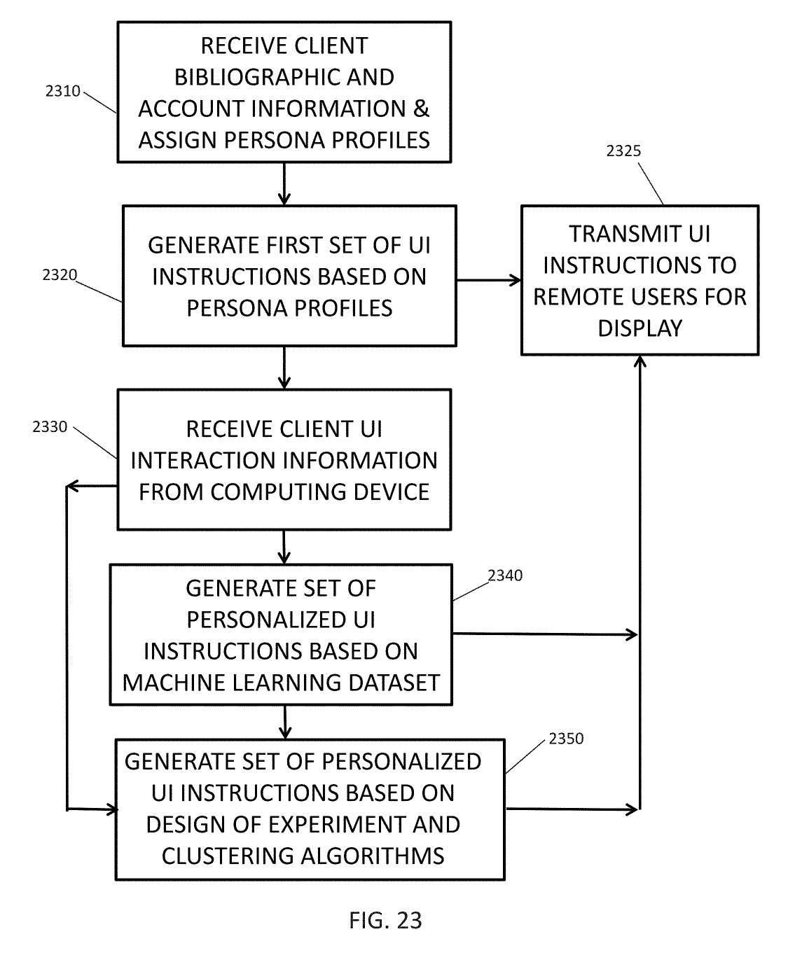

FIG. 23 depicts another illustrative method for generating user interfaces based on persona profiles and modifying the user interfaces based on subsequent client user interface interactions in accordance with one or more example embodiments. At step 2310, a first content stream containing bibliographic information and account information for a plurality of clients is received by a processor of a computing platform via a communication interface from a content management system and used to assign persona profiles. A first set of user interface instructions is generated 2325 based on the persona profiles for display on respective remote client devices. At step 2330, a second content stream containing data of client interactions with the user interface is received via the communication interface from an enterprise tagging server. Personalized user interface instructions are generated 2340 based on a machine learning data set, and transmitted to the respective remote client devices for display thereon. Subsequent client user interface interaction data 2330 also may be analyzed using a design of experiment instructions and/or clustering algorithms 2350 to modify the personalized user interface instructions for transmission 2325 to the respective remote client devices.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any or all of the method steps described herein may be implemented as computer-readable instructions stored on a computer-readable medium, such as a non-transitory computer-readable medium. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

We claim:

1. A computing platform, comprising:
at least one processor;
a communication interface communicatively coupled to the at least one processor; and
memory storing computer-readable instructions that, when executed by the at least one processor, cause the computing platform to:
receive, via the communication interface, from a content management system, a first content stream containing bibliographic information and account information for a plurality of clients and, based thereon, assign a persona profile to each client from a plurality of predetermined persona profiles;
generate a first set of user interface instructions based on the assigned persona profile for each client and transmit the first set of user interface instructions to respective remote client devices via the communication interface;
receive, via the communication interface, from an enterprise tagging server, a second content stream containing data of user interface interactions for the plurality of clients; and
responsive to receiving the second content stream, based on a machine learning dataset, generate a set of personalized user interface instructions and transmit the set of personalized user interface instructions to respective remote client devices via the communication interface.

2. The computing platform of claim 1, wherein the first content stream includes one or more of age information, education information, occupation information, income information, account type information, assets under management information, holdings information, holding product class information, industry sector information, and days since account opening information.

3. The computing platform of claim 1, wherein second content stream includes one or more of online login frequency information, mobile login frequency information, online banking login frequency information, page visit information, click path information, trade frequency information, and transfer frequency information.

4. The computing platform of claim 1, wherein the memory stores additional computer-readable instructions that, when executed by the at least one processor, cause the computing platform to:
receive, via the communication interface, from a design of experiment engine, design of experiment instructions; and
based on the design of experiment instructions, modify the set of personalized user interface instructions and transmit the set of modified personalized user interface instructions to respective remote client devices via the communication interface.

5. The computing platform of claim 4, wherein the memory stores additional computer-readable instructions that, when executed by the at least one processor, cause the computing platform to:
receive, via the communication interface, a clustering algorithm for grouping clients having similar persona profiles and user interaction data; and
based on the clustering algorithm and design of experiment instructions, modify the set of personalized user interface instructions and transmit the set of modified personalized user interface instructions to respective remote client devices via the communication interface.

6. The computing platform of claim 4, wherein the memory stores additional computer-readable instructions that, when executed by the at least one processor, cause the computing platform to:
receive, via the communication interface, instructions from a channel analytics site based on business criteria; and
based on the instructions from the channel analytics site, modify the set of personalized user interface instructions and transmit the set of modified personalized user interface instructions to respective remote client devices via the communication interface.

7. The computing platform of claim 4, wherein the memory stores additional computer-readable instructions that, when executed by the at least one processor, cause the computing platform to:
receive, via the communication interface, instructions from a channel analytics site based on vendor data; and
based on the instructions from the channel analytics site, modify the set of personalized user interface instructions and transmit the set of modified personalized user interface instructions to respective remote client devices via the communication interface.

8. A method, comprising:
at a computing platform comprising at least one processor, memory, and a communication interface:
receiving, via the communication interface, from a content management system, a first content stream containing bibliographic information and account information for a plurality of clients and, based thereon, assigning a persona profile to each client from a plurality of predetermined persona profiles;
generating a first set of user interface instructions based on the assigned persona profile for each client and transmitting the first set of user interface instructions to respective remote client devices via the communication interface;
receiving, via the communication interface, from an enterprise tagging server, a second content stream containing data of user interface interactions for the plurality of clients; and
responsive to receiving the second content stream, based on a machine learning dataset, generating a set of personalized user interface instructions and transmitting the set of personalized user interface instructions to respective remote client devices via the communication interface.

9. The method of claim 8, wherein the first content stream includes one or more of age information, education information, occupation information, income information, account type information, assets under management information, holdings information, holding product class information, industry sector information, and days since account opening information.

10. The method of claim 8, wherein second content stream includes one or more of online login frequency information, mobile login frequency information, online banking login frequency information, page visit information, click path information, trade frequency information, and transfer frequency information.

11. The method of claim 8, further comprising:
receiving, via the communication interface from a design of experiment engine, design of experiment instructions; and
based on the design of experiment instructions, modifying the set of personalized user interface instructions and transmitting the set of modified personalized user interface instructions to respective remote client devices via the communication interface.

12. The method of claim 11, further comprising:
receiving, via the communication interface, a clustering algorithm for grouping clients having similar persona profiles and user interface interaction data; and
based on the clustering algorithm and the design of experiment instructions, modifying the set of personalized user interface instructions and transmitting the set of modified personalized user interface instructions to respective remote client devices via the communication interface.

13. The method of claim 11, further comprising:
receiving, via the communication interface, instructions from a channel analytics site based on business criteria; and
based on the instructions from the channel analytics site and the design of experiment instructions, modifying the set of personalized user interface instructions and transmitting the set of modified personalized user interface instructions to respective remote client devices via the communication interface.

14. The method of claim 11, further comprising:
receiving, via the communication interface, instructions from a channel analytics site based on vendor data; and
based on the instructions from the channel analytics site and the design of experiment instructions, modifying the set of personalized user interface instructions and transmitting the set of modified personalized user interface instructions to respective remote client devices via the communication interface.

15. One or more non-transitory computer-readable media storing instructions that, when executed by a computing platform comprising at least one processor, memory, and a communication interface, cause the computing platform to:
receive, via the communication interface, from a content management system, a first content stream containing bibliographic information and account information for a plurality of clients and, based thereon, assign a persona profile to each client from a plurality of predetermined persona profiles;
generate a first set of user interface instructions based on the assigned persona profile for each client and transmit the first set of user interface instructions to respective remote client devices via the communication interface;
receive, via the communication interface, from an enterprise tagging server, a second content stream containing data of user interface interactions for the plurality of clients; and
responsive to receiving the second content stream, based on a machine learning dataset, generate a set of personalized user interface instructions and transmit the set of personalized user interface instructions to respective remote client devices via the communication interface.

16. The non-transitory computer-readable media of claim 15, further comprising additional instructions that, when executed by the computing platform, cause the computing platform to:
receive, via the communication interface from a design of experiment engine, design of experiment instructions; and
based on the design of experiment instructions, modify the set of personalized user interface instructions and transmit the set of modified personalized user interface instructions to respective remote client devices via the communication interface.

17. The non-transitory computer-readable media of claim 16, further comprising additional instructions that, when executed by the computing platform, cause the computing platform to:
receive, via the communication interface, a clustering algorithm for grouping clients having similar persona profiles and user interface interaction data; and
based on the clustering algorithm and design of experiment instructions, modify the set of personalized user interface instructions and transmit the set of modified personalized user interface instructions to respective remote client devices via the communication interface.

18. The non-transitory computer-readable media of claim 16, further comprising additional instructions that, when executed by the computing platform, cause the computing platform to:
receive, via the communication interface, instructions from a channel analytics site based on business criteria; and
based on the instructions from the channel analytics site and the design of experiment instructions, modify the set of personalized user interface instructions and transmit the set of modified personalized user interface instructions to respective remote client devices via the communication interface.

19. The non-transitory computer-readable media of claim 16, further comprising additional instructions that, when executed by the computing platform, cause the computing platform to:
receive, via the communication interface, instructions from a channel analytics site based on vendor data; and
based on the instructions from the channel analytics site and the design of experiment instructions, modify the set of personalized user interface instructions and transmit the set of modified personalized user interface instructions to respective remote client devices via the communication interface.
